(19) United States
(12) Patent Application Publication
(10) Pub. No.: US 2006/0253577 A1
(43) Pub. Date: Nov. 9, 2006

(54) Method, system and computer program for the secured management of network devices

(76) Inventors: Luca Castaldelli, Torino (IT); Davide Moreo, Torino (IT); Marco Polano, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/558,835

(22) PCT Filed: May 29, 2003
(86) PCT No.: PCT/EP03/05654

§ 371 Date: Nov. 29, 2005

(51) Int. Cl. G06F 15/173

(52) U.S. Cl. 709/225

(57) ABSTRACT

A method of managing communications between a first system and a second system in a communication network, includes the steps of negotiating at least one cipher key between the first and second systems, and communicating information between the first and second systems using the SNMP protocol and the cipher key. Negotiation of the cipher key is carried out as a ciphered transaction and security processes are preferably adopted to cipher the sensitive information exchanged over the SNMP protocol. Preferably the cipher key is allotted a limited duration in time and a new cipher key is negotiated when such a duration is completed.

### FIELD OF THE INVENTION

The present invention relates to managing network devices and more specifically deals with managing communications between a first system and a second system, such systems being constituted e.g. by those elements in a telecommunication network currently referred to as “element manager” and “network access device”.

### DESCRIPTION OF THE RELATED ART

Communication between an “element manager” and a “network access device” currently takes place by resorting to the protocol designated SNMP (an acronym for Simple Network Management Protocol). For general information concerning SNMP reference can be made e.g. to any of the following publications:

Jonathan Saperia, SNMP at the Edge, McGraw-Hill Professional, 2002, ISBN: 0-07-139689-6

David T. Perkins, Evan McGinnis, Understanding SNMP MIBs, Prentice Hall, 1997, ISBN: 0-13-437708-7

Marshall T. Rose, Keith McCloghrie, How to Manage Your Network Using SNMP: The Networking Management Practicum, Prentice Hall, 1995, ISBN: 0-13-145117-0

In the version most commonly used at present (SNMP v3), this protocol adopts a DES cipher algorithm over 56 bits.

Arrangements are also known using the 3DES cipher algorithm, which is a variant of the basic DES algorithm adapted to be implemented in different ways.

One exemplary embodiment is represented by the standard designated ANSI X9.52.

In WO-A-01/24444 an arrangement is disclosed using the so-called Diffie-Hellman algorithm. This is used to generate a key that is used to open a session by using a SNMP v3 protocol. Additionally, a third system, designated remote server, is used to exchange the keys required to start communication with the SNMP protocol.

### OBJECT AND SUMMARY OF THE INVENTION

The need therefore exists for an arrangement adapted to overcome the intrinsic drawbacks of such prior art arrangements, especially as regards security of communication and protection of information held to be important and sensitive.

The object of the present invention is to provide such an improved arrangement.

According to the present invention, such an object is achieved by means of a method having the features set forth in the claims that follow. The invention also relates to systems configured for operating according to the method of the invention and a computer program product directly loadable in the memory of a computer and including software code portions for performing the steps of the method of invention when the product is run on a computer.

Essentially, the preferred embodiment of the arrangement disclosed herein provides for the use of a number of security measures in order to strengthen protection of communication between two systems (or sub-systems) in a communication network based on an SNMP protocol which adopts a cipher algorithm, such as the SNMP v3 protocol commonly used at present.

These may include a strong ciphering algorithm, e.g. 3DES ciphering (according to a technique that is well known per se), in order to make the whole system more secure in terms of protection of information being exchanged.

Preferably, strong ciphering (or encryption: the two terms are being used indifferently throughout this description and the claims appended thereto) is adopted during the negotiation phase of the keys required for initialising the SNMP session.

A preferred embodiment of the invention is thus a method of managing communications between a first system and a second system in a communication network, including the steps of negotiating at least one cipher key (Ks) between said first and second systems, and communicating information between said first and second system using the SNMP protocol and said cipher key (Ks). Negotiating said at least one cipher key (Ks) is carried out as a ciphered (e.g. encrypted) transaction, in order to provide a strong protection of the key exchange process.

To communicate information a session is started between the two systems, the session having preferably a limited duration in time (this duration being e.g. less than 30 minutes), this duration being preferably adjustable e.g. to possibly reduce the length thereof to reduce the likelihood of the session keys being possibly accessed to by unauthorised parties.

Additionally, strong ciphering is preferably adopted also for the information held to be sensitive and significant within the SNMP v3 packet.

A preferred embodiment of the arrangement disclosed herein uses the Hughes algorithm, protecting exchange of keys by resorting to the 3DES system. Exchange of the keys necessary in order to start communication with the SNMP protocol takes place directly between the two systems involved, thereby dispensing with the intervention of any intermediary system. As indicated, the duration of the session is limited in time and the information held to be significant is coded in a strong manner by resorting to the 3DES technique and then conveyed by resorting to the SNMP protocol.

A typical SNMP v3 session uses a 56-bit key and, in the arrangement disclosed herein, the duration is limited to a maximum value of thirty minutes. Once the session is completed or once the maximum time has lapsed a new 56-bit key is negotiated. By resorting to this technique, the 56-bit key is protected from being used to proceed to unauthorised re-configuration of the network access device. In fact, a typical de-ciphering time for such a key is presently estimated to be in the range of 2 to 3 hours, which in any case is abundantly more than the maximum indicated value of thirty minutes. Such a maximum duration is adapted to be shortened to take into account the possible expected reduction of de-ciphering time in the future.

The algorithm for generating the 56-bit session key is the Hughes algorithm (based on modulo arithmetic) that requires a contribution from both systems in the exchange of information to generate the key.

Specifically, the Hughes algorithm is a variant of the basic Diffie-Hellman algorithm allowing a first system to generate a key and send it to a second system.

The first system chooses a random large integer x and generates K=g^{x} mod p, where g is a random number and p is a prime number.

The second system chooses in turn a random large integer y, generates Y=g^{y} mod p and sends Y to the first system.

The first system generates X=Y^{x} mod p and sends it to the second system.

The second system computes
z=y⁻¹ (or, more precisely, z=y⁻¹ mod (p−1))
K′=X^{z} mod p.
If the process is carried out correctly, K=K′.

Possible interception and decryption of the SNMP communications would involve reading the MIB (Management Information Base) variables of the network access device written by the element manager.

This information is essentially of two types:
information concerning setting of the device, that per se are not particularly important from the viewpoint of security, and
information held to be particularly significant for security purposes, such as passwords or keys.

The access keys and other significant information might therefore be obtained e.g. by off-line decrypting the SNMP communications and then used in an unauthorised way to re-configure the network access device. Consequently, additional measures are preferably taken in order that these sensitive data are further encrypted by means of the 3DES algorithm over 128 bits to be then transferred by resorting to the SNMP v3 algorithm.

Possible unauthorised decryption of such a protocol may lead only to deriving access keys that are illegible insofar as they are encrypted over e.g. 128 bit, which can be regarded as a reasonably secure ciphering system.

In the following, reference will be made primarily—by way of example only—to communication taking place between:
a first system comprised of a so-called “element manager”, in the role of a master element, and
a second system comprised of a so-called “network access device” in the role of a client/agent element.

The invention is however applicable to any other scenario involving communication between a notionally unlimited number of systems adapted to communicate via a SNMP protocol.

### BRIEF DESCRIPTION OF THE ANNEXED DRAWINGS

The invention will now be described, by way of non-limiting example only, with reference to the enclosed figures of drawing, wherein:

FIG. 1 is a first flow chart related to generation of a temporary key within the system disclosed herein,

FIG. 2 is another flow chart representing SNMP communication within a system and

FIG. 3 is another flow chart representing high security SNMP communications.

### DETAILED DESCRIPTION OF PREFERRED EMBODIMENTS OF THE INVENTION

In the following, generation of a temporary key and subsequent SNMP communication will be represented as taking place between two elements included in a communication network and, more specifically, between two elements devoted to a managing function of the network (not shown as a whole).

Specifically, the two elements in question are a so-called “element manager” and a so-called “network access device” (or “agent”). These designations and the meaning thereof are well known to those of skill in the art thus making it unnecessary to provide a detailed description herein.

The arrangement disclosed herein essentially represents an improvement of current SNMP communication schemes adopted within the same scenario. Again, the basic operating principles and criteria of such communication schemes are held to be completely known to those of skill in the art (as witnessed e.g. by WO-A-01/24444).

Essentially, in the invention, the basic processing tasks to be implemented both at the element manager side and at the network access device side are the following:
a SNMP communication protocol adopting a ciphering algorithm, such as SNMP v3 (DES algorithm),
the Hughes algorithm,
the 3DES algorithm,
a MIB variable to contain a key K′=K, and
another MIB variable adopted to indicate the duration allotted to the key K′=K (if this is not communicated, a default parameter—typically with a maximum value of 30 minutes—is used as contained in the agent firmware).

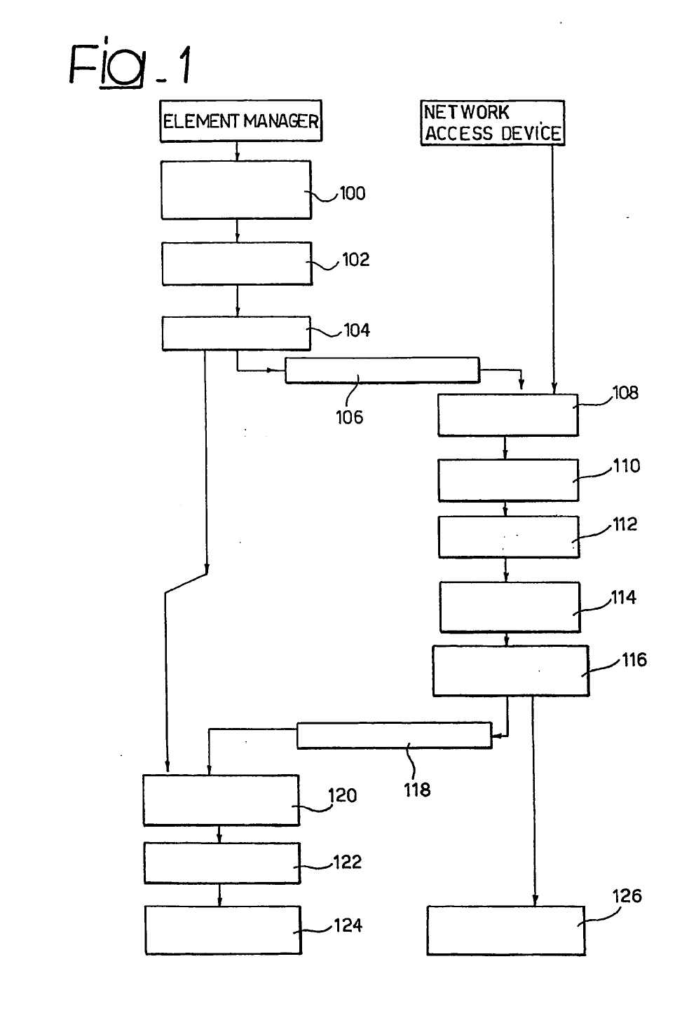

Specifically, in the flow chart of FIG. 1 the steps carried out with the element manager and the steps carried with the network device manager are represented on the left-hand side and the right-hand side of the page, respectively.

As a first step, designated, 100 the element manager generates a random number y, that is passed on together with two ciphering variables p and g to the Hughes algorithm that computes a key Y. The two cipher keys or parameters p and g are set during the implementation phase and made permanent.

In a subsequent step 102, the key Y is encrypted by using the 3DES algorithm by using a key K1 including 128 bits.

The key K1 is set during the implementation phase and made permanent, so that it is well known to both the element manager and the network access device.

The SNMP communications effected before the temporary key Ks is shared are protected by a 56 bit fixed key Kf, known a priori by the two systems.

In a step 104, the encrypted key Y is sent towards the network device manager by using the SNMP v3 protocol.

Step 106 designates transmission proper, while upon reception in a step 108 the network device manager decrypts the key Y with the 3DES algorithm by using the key K1 including 128 bits.

In a subsequent step 110, the network device manager generates a random number x, which is passed together with the ciphering variables p and g to the cipher algorithm.

In a subsequent step 112, the network device manager computes a key X by using the Hughes algorithm based on Y and x.

In a step 114, the key X is encrypted by using the 3DES algorithm by once more using the key K1 including 128 bits.

At this point, in a step 116 the reading of X is made available to the element manager via the SNMP v3 algorithm.

The corresponding transmission step is designated 118, and in a subsequent step 120 the element manager reads and decrypts the X key by using the 3DES algorithm by exploiting the key K1 including 128 bits.

In a subsequent step 122 the element manager computes, again by using the Hughes algorithm, a key K′ by using X and y.

Finally, in a step designated 124, the element manager derives from the key K′ a further communication key Ks, including 128 bits, for use in communicating information by using the SNMP v3 protocol (that in fact uses only 56 bits).

In parallel, in a step 126, the network device manager derives from X and y a key K that is equal to K′.

From the key K(=K′) the network device manager derives the further communication key Ks, including 56 bits, for use in communicating information by using the SNMP v3 protocol.

At this point the element manager and the network device manager are ready for communication via the SNMP protocol, by opening a session with key Ks. The negotiation process of the communication key Ks (which process involves the generation and the exchange of the information necessary for producing such a key) having been carried out essentially as a secure process.

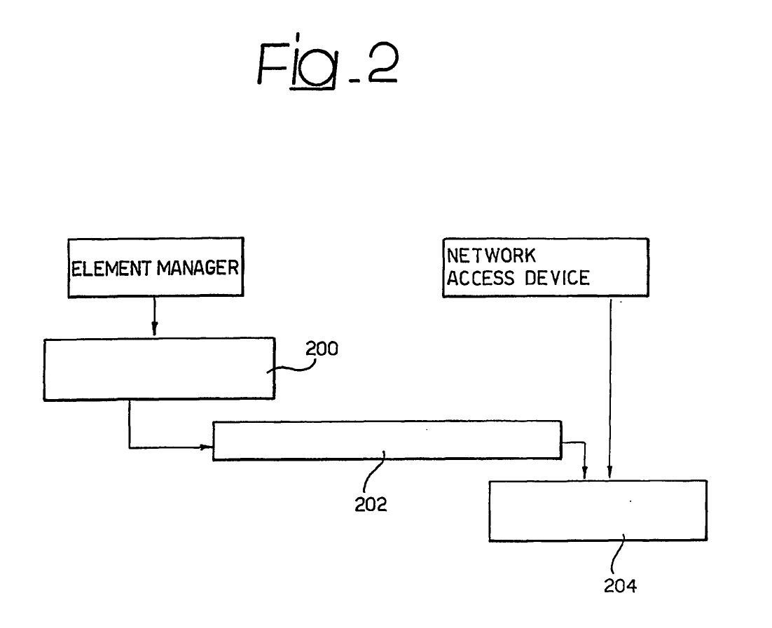

FIG. 2 schematically portrays the typical layout of a SNMP communication process.

In general terms this involves:
a step 200, which is essentially a configuration phase involving write/read operations by the element manager by using the SNMP v3 protocol with the key Ks at 56 bits; the write operations may involve writing configuration parameters into the network device, while the read operations typically involve reading the parameters written to check the correctness thereof and/or reading information concerning the operational state of the network access device,
a step 202 involving transmission of the MIB parameters from the element manager to the network device manager, and
a step 204, wherein the network device manager acquires the configuration parameters with the SNMP v3 protocol by using the key Ks at 56 bits.

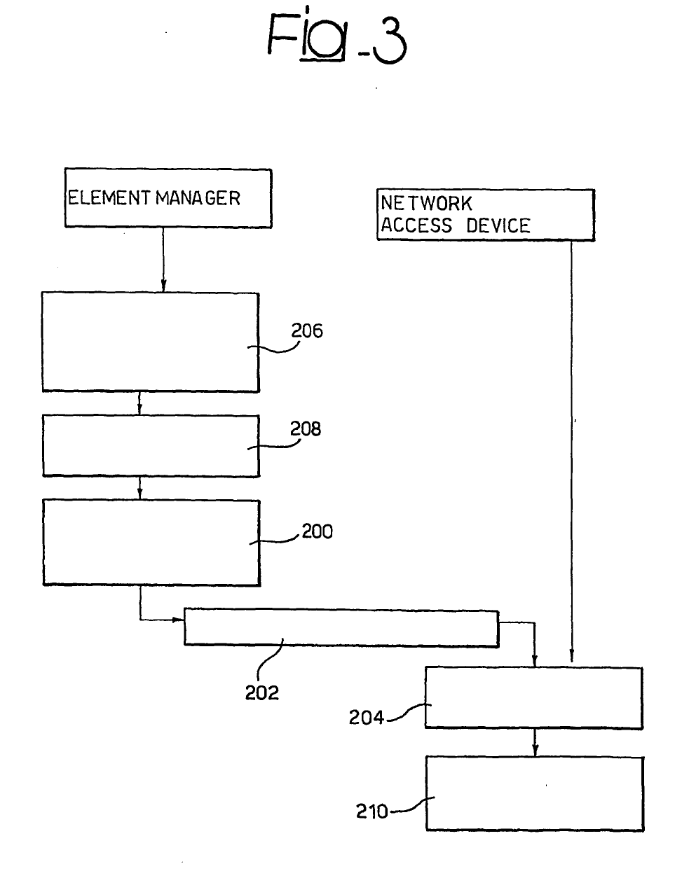

The diagram of FIG. 3 represents a preferred embodiment of the arrangement disclosed wherein the step 200 is preceded by two steps designated 206 and 208, respectively.

Essentially, in step 206 the element manager checks if “sensitive” parameters/information are to be transmitted.

If this is the case, in the subsequent step 208 the sensitive information/parameters (e.g. username, password and so on) are ciphered by using the 3DES algorithm and the key K1.

In a complementary manner, the step 204 is followed by an additional step 210 wherein the sensitive information is deciphered by using again the 3DES algorithm and the key K1 at 128 bits.

Those of skill in the art will promptly appreciate that the element manager and the network access device may exchange their roles in performing the calculations to which the diagram of FIG. 1 refers. Specifically, this may be done by allotting to the network access device the task of generating the variable Y while allotting to the element manager the task of generating the variable X and by correspondingly assigning to the element manager those tasks that in the diagram of FIG. 1 are portrayed as assigned to the network access device and vice-versa.

Of course, if such an “exchanged” or “swapped” arrangement is adopted, the element manager will issue (by using e.g. the SNMP protocol) a message indicating to the network access device the start of communication. Such a message being sent from the element manager to the network access device prompts transmission of the ciphered first negotiation key (Y) from the network access device to the element manager.

The arrangement described herein achieves a higher degree of security by using the Hughes algorithm when exchanging the keys between the two systems that communicate with each other (in the instant case, an element manager and a network device manager) using the SNMP protocol, protecting the key exchange process by means of a strong ciphering algorithm.

At least certain data, held to be particularly important or sensitive, are ciphered by using the 3DES algorithm by using the key K1 before being transmitted to the network access device or agent.

They are inserted only at this time in the respective MIB variable and transmitted by using the protocol SNMP v3 by using the key Ks. When received by the network access device, the SNMP v3 packet is opened by using the key Ks and deciphered by using the same 3DES algorithm.

The key Ks has a temporary duration that can be set, e.g. at the maximum value of 30 minutes. This duration may be also be selectively defined from time to time and comprise an information item that is transmitted by the element manager towards the network access device as a parameter indicative of the lease time of the key Ks.

Once the key Ks lapses, a new temporary key (Ks₂, Ks₃, . . . , Ksₙ) can be negotiated by using the same process defined in the foregoing.

It will be appreciated that as an alternative to 3DES, other strong cipher algorithms can be used in protecting the exchange of keys for the SNMP session and/or the significant, sensitive information.

Exemplary of such processes are digital signatures, public or private key digital certificates such as defined in ITU-TX.509 and described e.g. in U.S. Pat. No. 4,405,829 (and currently referred to as RSA, an acronym for Rivest-Shamir-Adleman).

As an alternative to the Hughes algorithm, other methods can be used for generating the keys to be applied to the SNMP session: exemplary of such alternative methods are the Diffie-Hellman, ElGamal, and Merkle-Hellman algorithms.

It is therefore evident that, without prejudice to the underlying principle of the invention, the details and embodiments may vary, also significantly, with respect to what has been disclosed and shown by way of example only without departing from the scope of the invention as defined by the annexed claims.

1-29. (canceled)

30. A method of managing communications between a first system and a second system in a communication network, comprising the steps of:
negotiating at least one cipher key between said first and second systems, and
communicating information between said first and second systems using the SNMP protocol and said cipher key,
the step of negotiating said at least one cipher key being carried out as a ciphered transaction.

31. The method of claim 30, comprising the step of using a ciphering process in negotiating said at least one cipher key.

32. The method of claim 31, wherein said ciphering process is selected from the group consisting of the Hughes algorithm, the Diffie-Hellman algorithm, the ElGamal algorithm, and the Merkle-Hellman algorithm.

33. The method of claim 32, wherein said ciphering process is based on the Hughes algorithm.

34. The method of claim 30, comprising the step of making said cipher key available to both said first and second systems by using a security process.

35. The method of claim 34, wherein said security process is selected from the group consisting of the 3DES algorithm, digital signatures, public or private key digital certificates, and RSA.

36. The method of claim 34, wherein said security process is the 3DES algorithm.

37. The method of claim 30, comprising the step of allotting a pre-defined time duration to said cipher key.

38. The method of claim 37, wherein said duration is less than 30 minutes.

39. The method of claim 37, comprising the step of making said duration selectively adjustable.

40. The method of claim 30, comprising the steps of:
generating a first negotiation key,
ciphering said first negotiation key by using a negotiation cipher algorithm and a respective key;
sending said ciphered first negotiation key from said first system to said second system;
deciphering said first negotiation key at said second system by using said respective key;
generating at said second system a second negotiation key from said first negotiation key;
ciphering said second negotiation key by using said negotiation cipher algorithm and said respective key;
transmitting said ciphered second negotiation key from said second system to said first system;
deciphering said second negotiation key at said first system by using said negotiation cipher algorithm and said respective key; and
generating said at least one cipher key at said first and at said second systems based on said second negotiation key.

41. The method of claim 40, comprising the step of configuring said first system and said second system as an element manager and a network access device, respectively, in a telecommunication network.

42. The method of claim 40, comprising the steps of:
configuring said first system and said second system as a network access device and an element manager, respectively, in a telecommunication network; and
sending from said element manager to said network access device a message indicating start of communication, thus prompting sending said ciphered first negotiation key from said network access device to said element manager.

43. The method of claim 40, wherein said negotiation cipher algorithm is a 3DES algorithm.

44. The method of claim 40, comprising the step of generating said first negotiation key and said second negotiation key by using the Hughes algorithm.

45. The method of claim 44, comprising the step of generating said first negotiation key and said second negotiation key starting from a respective, randomly generated number and two parameters jointly shared by said first and second systems.

46. The method of claim 40, comprising at least one step selected from the group consisting of:
sending said ciphered first negotiation key from said first to said second system by using a SNMP protocol, and
sending said ciphered second negotiation key from said second system towards said first system by using a SNMP protocol.

47. The method of claim 40, wherein said respective key is a 128-bit key.

48. The method of claim 30, comprising:
identifying in said information to be communicated between said first and said second system a set of sensitive information;
ciphering said sensitive information by using an information protection method;
transmitting said information including said ciphered sensitive information from said first to said second system; and
deciphering said sensitive information at said second system by using said information protection method.

49. The method of claim 48, comprising the step of making said cipher key available to both said first and second systems by using a security process and the step of selecting said security process identical to said information protection method.

50. The method of claim 49, wherein said security process and said information protection method are the 3DES algorithm.

51. The method of claim 30, comprising the step of defining an MIB variable to include said cipher key.

52. The method of claim 30, comprising the step of defining a respective MIB variable conveying a time duration of said cipher key.

53. The method of claim 30, comprising the step of allotting a defined time duration to said cipher key.

54. The method of claim 53, wherein said defined time duration is less than 30 minutes.

55. The method of claim 53, comprising the steps of:
detecting said cipher key having completed said allotted duration time; and
negotiating between said first and said second systems at least one new cipher key.

56. A system configured to operate as said first system in the method of any one of claims 30, 31, 34, 37, 39-42, 44-46, 48, 49, 51-53 and 55.

57. A system configured to operate as said second system in the method of any one of claims 30, 31, 34, 37, 39-42, 44-46, 48, 49, 51-53 and 55.

58. A computer program product directly loadable in the memory of at least one computer and including software code portions for implementing the steps of the method of any one of claims 30, 31, 34, 37, 39-42, 44-46, 48, 49, 51-53 and 55.
